(19) United States
(12) Patent Application Publication
(10) Pub. No.: US 2012/0253554 A1
(43) Pub. Date: Oct. 4, 2012

(54) RC Car Anti-Flip System and Methods

(76) Inventor: Stanton Mark Hamilton, Littleton, CO (US)

(21) Appl. No.: 13/525,278

(22) Filed: Jun. 16, 2012

(51) Int. Cl. B60T 8/24; G05D 1/02

(52) U.S. Cl. 701/2; 701/72

(57) ABSTRACT

A car control system, a car including a car control system, and methods for using such.

### BACKGROUND OF THE INVENTION

The present invention is related to motion control in an automobile, and more particularly to control of a radio control (RC) car.

As RC cars continue to get more and more powerful, control of the car becomes more difficult. This difficulty often renders the utility of the vehicle and/or results in damage to the vehicle.

Thus, for at least the aforementioned reasons, there exists a need in the art for more advanced approaches, devices and systems for RC car control.

### BRIEF SUMMARY OF THE INVENTION

The present invention is related to motion control, and more particularly to control of a radio control (RC) car.

A car control system including a drive system operable to apply power to one or more wheels of a car; an acceleration sensor operable to sense an acceleration of the car along an axis of the car and to provide an acceleration signal corresponding to the acceleration; and an acceleration governor operable to reduce power applied by the drive system when the acceleration signal exceeds a threshold. In some instances of the aforementioned embodiments, the threshold is a first threshold, and the acceleration governor is operable to allow an increase in power applied by the drive system when the acceleration signal drops below a second threshold. In various cases, the car is a radio control car. In one or more cases, the acceleration governor is a circuit implemented as part of an integrated circuit. In particular cases, at least a portion of the acceleration sensor is implemented as part of the integrated circuit.

In various instances of the aforementioned embodiments, the acceleration governor is operable to reduce power applied by the drive system by providing a gating signal to the drive system that causes the drive system to pulse the power applied to the one or more wheels of the car. In one or more instances of the aforementioned embodiments, the acceleration is lateral acceleration.

In some instances of the aforementioned embodiments, the control system further includes a radio frequency receiver operable to receive one or more commands. In some such instances, the one or more commands may be, for example, steering commands and power commands. In particular instances, the power command indicates a power level to be applied by the drive system. In particular instances, the drive system is further operable to turn one or more wheels of the car to change direction of the car based upon receiving the steering command. In some cases, the acceleration governor is operable to reduce power applied by the drive system when the acceleration signal exceeds a threshold during implementation of each of a steering command and a power command.

This summary provides only a general outline of some embodiments according to the present invention. Many other objects, features, advantages and other embodiments of the present invention will become more fully apparent from the following detailed description, the appended claims and the accompanying drawings and figures.

### BRIEF DESCRIPTION OF THE DRAWINGS

A further understanding of the various embodiments of the present invention may be realized by reference to the figures which are described in remaining portions of the specification. In the figures, similar reference numerals are used throughout several drawings to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 is a block diagram of an RC Car including an anti-flip system in accordance with some embodiments of the present invention

FIG. 2 is a flow diagram illustrating a method in accordance with various embodiments of the present invention for RC car control;

FIG. 3 is a flow diagram that depicts RC car control in accordance with various embodiments of the present invention;

FIG. 4 is a graph depicting an example of an RC car control in accordance with some embodiments of the present invention;

FIG. 5 is a graph depicting another example of an RC car control in accordance with some embodiments of the present invention;

### DETAILED DESCRIPTION OF THE INVENTION

The present invention is related to motion control, and more particularly to control of a radio control (RC) car.

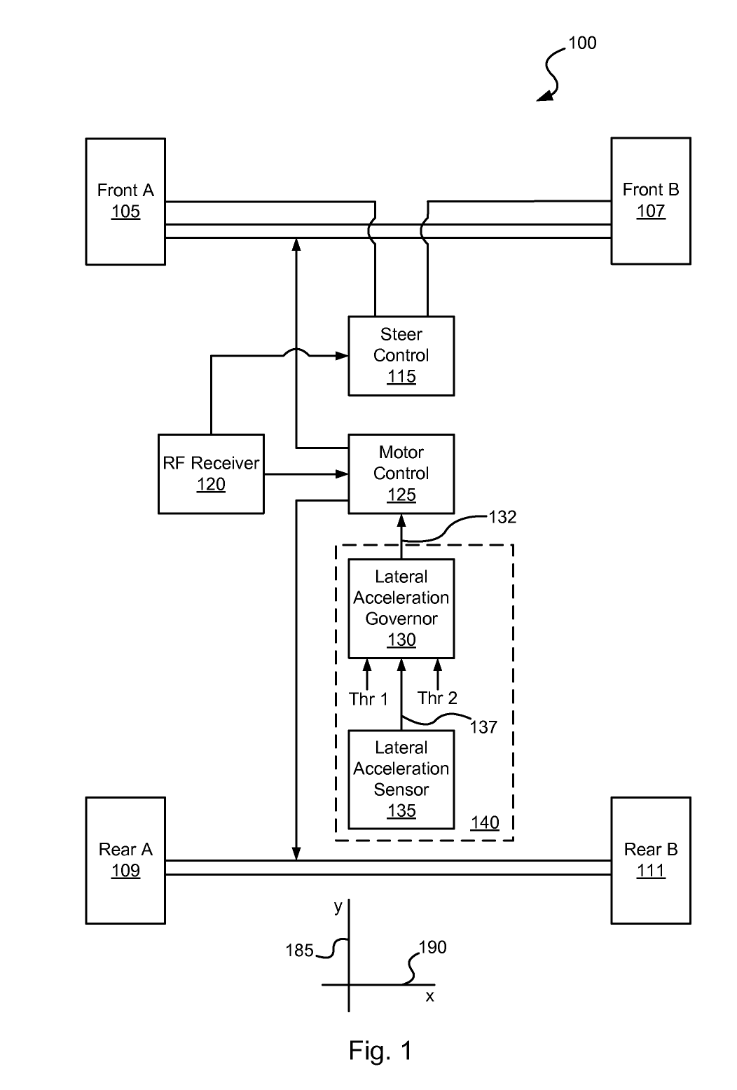

Turning to FIG. 1, a block diagram of an RC car 100 including an anti-flip system 140 shown in accordance with one or more embodiments of the present invention. RC car 100 includes a radio frequency (RF) receiver 120 operable to receive one or more RF commands. The RF commands may be any RF commands known in the art for controlling the operation of RC car 100. Such commands may include, but are not limited to steering commands and power commands. Where a steering command is received by RF receiver 120, RF receiver 120 formats the command and provides it to a steering control 115. In turn, steering control 115 controls the direction of RC car 100 by turning wheels (i.e., Front A 105 and Front B 107) in accordance with the received command. Where a power command is received by RF receiver 120, RF receiver 120 formats the command and provides it to a motor control 125. In turn, motor control 125 applies power to two or four of the wheels (i.e., Front A 105 and Front B 107; Rear A 109 and Rear B 111; or Front A 105, Front B 107, Rear A 109, and Rear B 111) in accordance with the received command. The process of receiving and applying steering and power commands may be done using any approach known in the art.

Anti-flip system 140 includes a lateral acceleration governor 130 and a lateral acceleration sensor 135. As used herein, the phrase “lateral acceleration” is used in its broadest sense to mean any acceleration or force in a direction other than that which the RC car is travelling (e.g., along an x-axis 190, a y-axis 185 representing a non-turning direction of RC car 100). Lateral acceleration sensor 135 is operable to indicate acceleration along an x-axis 190 relative to the orientation of the RC car. Lateral acceleration sensor 135 may be any accelerometer or other device known in the art that is capable of indicating an acceleration or force along x-axis 190. Lateral acceleration sensor 135 provides an acceleration indicator 137 to lateral acceleration governor 130. Acceleration indicator 137 may be an analog signal with the magnitude corresponding to the amount of sensed acceleration. Alternatively, acceleration indicator 137 may be a digital value with the magnitude of the digital value corresponding to the amount of sensed acceleration.

Lateral acceleration governor 130 is operable to interpret acceleration indicator 137 and to command motor control 125 to turn off or reduce power provided by motor control 125 to the wheels (i.e., Front A 105, Front B 107, Rear A 109, and Rear B 111). In particular, lateral acceleration governor provides a power control signal 132 that governs the amount of power provided to the wheels by motor control 125. Lateral acceleration governor 130 compares acceleration indicator 137 with an upper threshold value (i.e., Thr 1) and a lower threshold value (i.e., Thr 2). Where acceleration indicator 137 exceeds the upper threshold, lateral acceleration governor 130 asserts power control signal 132 such that power to the wheels is reduced. This reduction in power to the wheels reduces the lateral acceleration sensed by lateral acceleration sensor 135. This reduction in power continues until acceleration indicator 137 falls below the lower threshold at which time the power is re-applied by motor control 125 to the wheels. By reducing the power provided to the wheels when excess lateral acceleration is sensed, the possibility that the RC car will flip or otherwise lose control is reduced.

In some cases where power control signal 132 is a binary signal, power control signal 132 pulses on and off as acceleration indicator 137 goes below the lower threshold and increases above the upper threshold. This pulse may be used as an enable to motor control 125 where motor control 125 applies power to the wheels in accordance with a command received via RF receiver 120 until acceleration indicator 137 exceeds the upper threshold, and disallows application of the power to the wheels for the period between when acceleration indicator 137 exceeds the upper threshold and when it returns to below the lower threshold. This results in full application of power by motor control 125 followed by zero power during a power off period (i.e., the period between when acceleration indicator 137 exceeds the upper threshold and when it returns to below the lower threshold). This pulsing of the power effectively reduces the power applied to the wheels and thereby reduces the possibility of flipping RC car 100.

In other cases where power control signal 132 is a binary signal, power control signal 132 pulses on and off as acceleration indicator 137 goes below the lower threshold and increases above the upper threshold. This pulse may be used as an enable to motor control 125 where motor control 125 applies power to the wheels in accordance with a command received via RF receiver 120 until acceleration indicator 137 exceeds the upper threshold, and reduces application of the power to the wheels for the period between when acceleration indicator 137 exceeds the upper threshold and when it returns to below the lower threshold. This results in full application of power by motor control 125 followed by a reduced power during a power off period (i.e., the period between when acceleration indicator 137 exceeds the upper threshold and when it returns to below the lower threshold). This pulsing of the power effectively reduces the power applied to the wheels and thereby reduces the possibility of flipping RC car 100.

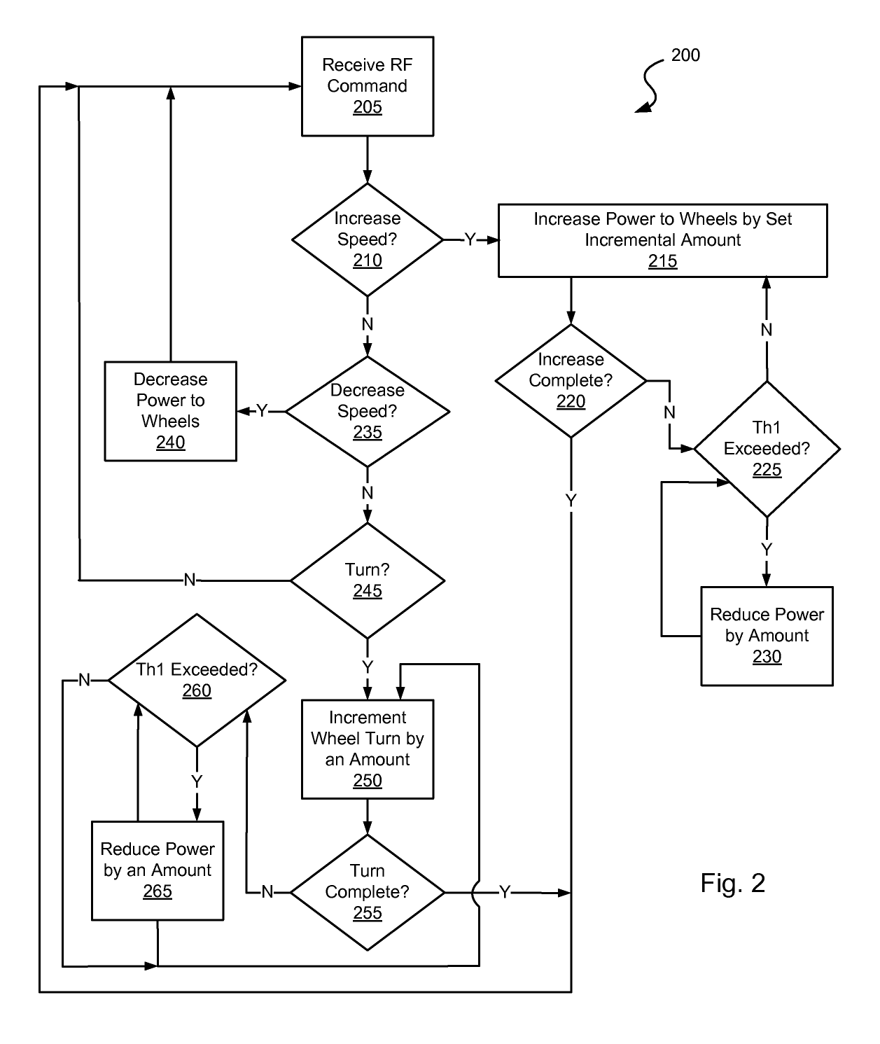

In other embodiments of the present invention, only a single threshold is used by lateral acceleration governor 130. This single threshold approach may be used similar to that described below in relation to FIG. 2. In such an approach, the possibility of flipping RC car 100 is reduced and the control of RC car 100 is enhanced.

It should be noted that one or more of the blocks of RC car 100 may be implemented as circuits. In some cases, such circuits may be implemented as part of an integrated circuit. The integrated circuit may include one of or more of the blocks on a single package. Alternatively, or in addition, one or more blocks of RC car 100 or portions thereof may be implemented in software or firmware and included a processor executing the software or firmware instructions to achieved the described operation.

Turning to FIG. 2, a flow diagram 200 illustrates a method in accordance with various embodiments of the present invention for RC car control. Following flow diagram 200, an RF command is received (block 205). The command may be any command known in the art including, but not limited to, a steering command or a power command. It is determined whether the received command indicates an increase in speed (i.e., application of additional power to the wheels)(block 210). Where the command indicates an increase in speed (block 210), power to the wheels of the RC car is increased by an incremental amount causing the car to increase in speed (block 215). It is determined whether the incremental increase in power completed the commanded increase (block 220). Where the commanded increase is not complete (block 220), it is determined whether a lateral acceleration threshold (i.e., Th1) has been exceeded (block 225). Where the lateral acceleration threshold has been exceeded (block 225), power applied to the wheels of the RC car is reduced by an amount (block 230). This reduction in power operates to reduce or control the amount of lateral acceleration, and thereby reduce the possibility of flipping the RC car. In some cases, the amount of power reduction is a full reduction (i.e., the power is reduced to zero). In other cases, the amount of power reduction is a portion of the power. This portion may be, for example, one half of the applied power. Based upon the disclosure provided herein, one of ordinary skill in the art will recognize a variety of amounts of power reduction that may be applied in accordance with different embodiments of the present invention.

It is determined whether the reduction in power was sufficient to reduce the lateral acceleration below the threshold (block 225). Where it is sufficient to reduce the lateral acceleration below the threshold (block 225), the processes of blocks 215 through 230 are repeated. The processes of blocks 215 through 230 are repeated until the received power command is completed.

Alternatively, where the command does not indicate an increase in speed (block 210), it is determined whether the command indicates a decrease in speed (block 235). Where the command indicates a decrease in speed (block 235), power is decreased to the wheels with the decrease corresponding to the command (bock 240). Alternatively, where the command does not indicate a decrease in speed (block 235), it is determined whether the command is a steering command indicating a turn (block 245).

Where the command is a steering command (block 245), the turning wheels of the RC car are turned an incremental amount in a direction corresponding to the received command (block 250). It is determined whether the incremental turn amount resulted in completion of the received steering command (block 255). Where the steering command has not yet completed (block 255), it is determined whether a lateral acceleration threshold (i.e., Th1) has been exceeded (block 260). Where the lateral acceleration has been exceeded (block 260), power applied to the wheels of the RC car is reduced by an amount (block 265). This reduction in power operates to reduce or control the amount of lateral acceleration, and thereby reduce the possibility of flipping the RC car. In some cases, the amount of power reduction is a full reduction (i.e., the power is reduced to zero). In other cases, the amount of power reduction is a portion of the power. This portion may be, for example, one half of the applied power. Based upon the disclosure provided herein, one of ordinary skill in the art will recognize a variety of amounts of power reduction that may be applied in accordance with different embodiments of the present invention.

Where either the lateral acceleration has not been exceeded (block 260) or the power had been reduced by the amount (block 265), the processes of blocks 250 through 265 are repeated. The processes of blocks 250 through 265 are repeated until the commanded turn is completed.

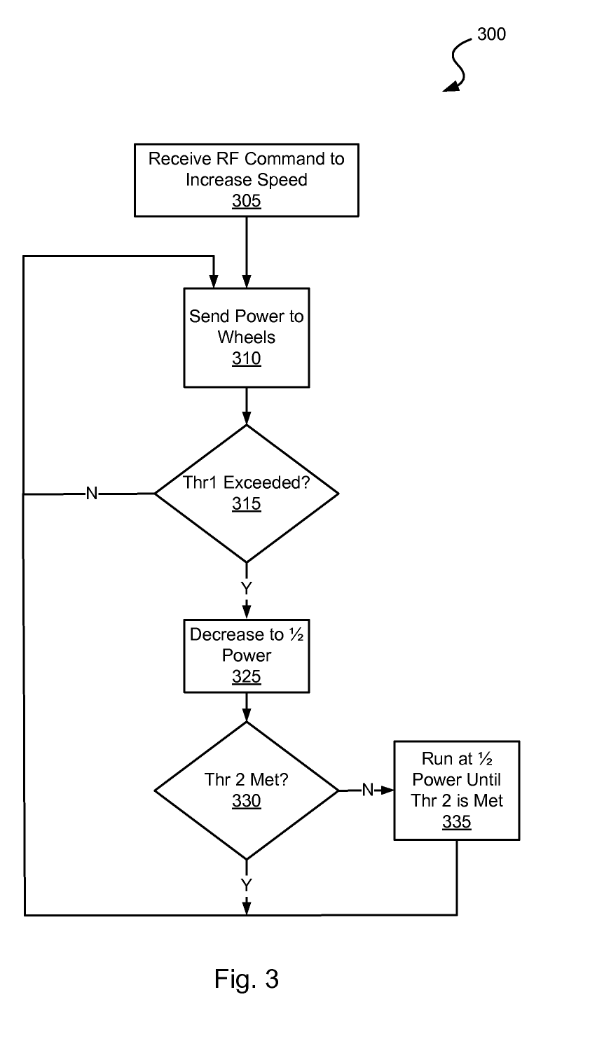

Turning to FIG. 3, a flow diagram 300 depicts RC car control in accordance with various embodiments of the present invention. Following flow diagram 300, an RF command is received commanding an increase in speed (i.e., an application of additional power to the wheels of the RC car)(block 305). In accordance with the command, additional power is applied to the wheels causing the RC car to accelerate (block 310). It is then determined if an upper lateral acceleration threshold (i.e. Th1) has been exceeded (block 315). Where the upper lateral acceleration threshold has been exceeded (block 315), the power applied to the wheels is reduced to one half power resulting in a reduction of the acceleration of the RC car (block 325). As the RC car is running at one half power the it will be determined if a lower lateral acceleration has met (i.e., Th2)(block 330). Where the lower lateral acceleration threshold has not been met (block 330), the power applied to the wheels will continue to run at one half the power. This half power application continues until the lower threshold is met (block 335) at which time full power is re-applied to the wheels (block 310). This reduction in power operates to reduce the lateral acceleration of the car, thereby reducing the possibility of the RC car flipping.

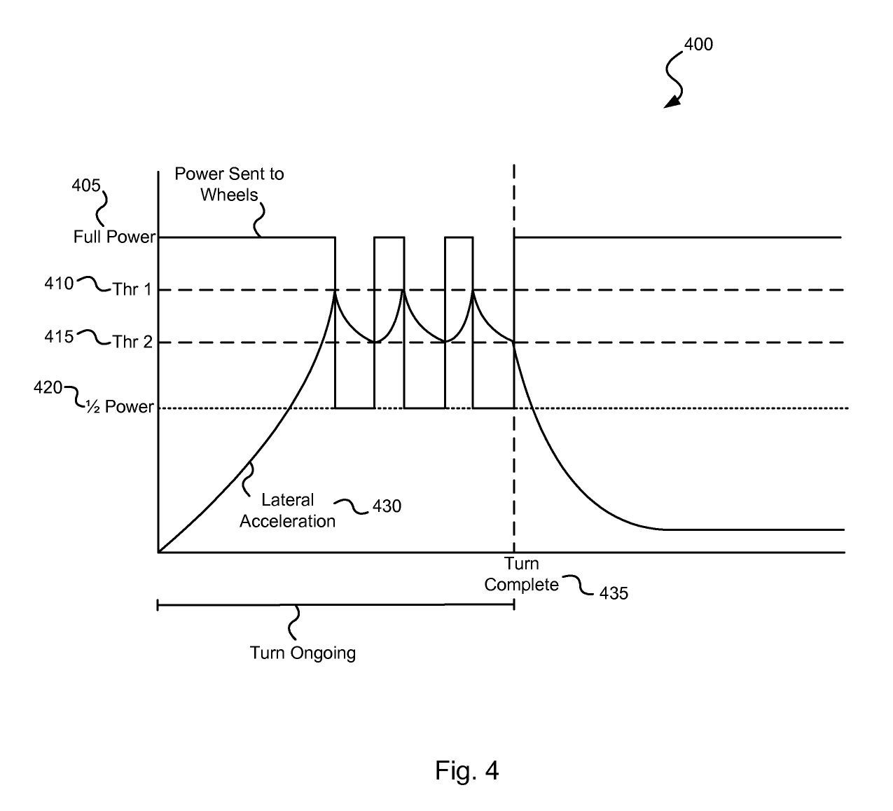

Turning to FIG. 4, a graph 400 depicts an example of an RC car control in accordance with some embodiments of the present invention. When full power 405 is commanded, the lateral acceleration 430 quickly increased and nears threshold 1 410. Threshold 1 being the point at which the lateral acceleration will cause the RC car to flip. When threshold 1 410 is reached, the anti-flip system activates and decreases the power sent to wheels to ½. The system then runs at ½ power 420 until threshold 2 415 is met, thus preventing the car from flipping. Threshold 2 being a point in which the lateral acceleration will be slowed enough for the RC car to retain control. At that point the system allows the car to be run at full power again, until threshold 1 410 is exceeded again. This pattern is repeated until the turn is completed 435.

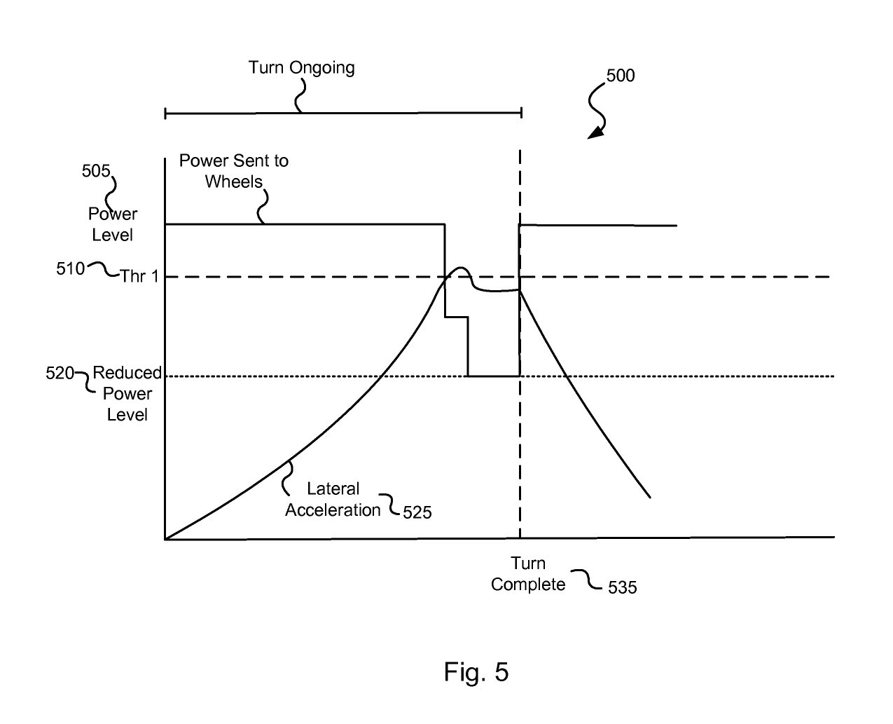

Turning to FIG. 5, a graph 500 depicts another example of an RC car control in accordance with some embodiments of the present invention. As the commanded amount of power is applied 505, the lateral acceleration 525 increases and nears threshold 1 510. When threshold 1 510 is reached, the anti-flip system activates and commands the RC car to run at a reduced power level 520. The system then runs at this set amount of power until threshold 1 510 is no longer exceeded, thus preventing the car from flipping. At that point the system allows the car to be run at full power again, until threshold 1 510 is exceeded again. This pattern will continue until the turn is completed 535.

In conclusion, the invention provides novel systems, devices, methods and arrangements for data processing. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A car control system, the system comprising:
a drive system operable to apply power to one or more wheels of a car;
an acceleration sensor operable to sense an acceleration of the car along an axis of the car and to provide an acceleration signal corresponding to the acceleration;
an acceleration governor operable to reduce power applied by the drive system when the acceleration signal exceeds a threshold.

2. The control system of claim 1, wherein the threshold is a first threshold, and wherein the acceleration governor is operable to allow an increase in power applied by the drive system when the acceleration signal drops below a second threshold.

3. The control system of claim 1, wherein the car is a radio control car.

4. The control system of claim 1, wherein the acceleration governor is a circuit implemented as part of an integrated circuit.

5. The control system of claim 4, wherein at least a portion of the acceleration sensor is implemented as part of the integrated circuit.

6. The control system of claim 1, wherein the acceleration governor is operable to reduce power applied by the drive system by providing a gating signal to the drive system that causes the drive system to pulse the power applied to the one or more wheels of the car.

7. The control system of claim 1, wherein the acceleration is lateral acceleration.

8. The control system of claim 1, wherein the control system further comprises:
a radio frequency receiver operable to receive one or more commands.

9. The control system of claim 8, wherein the one or more commands are selected from a group consisting of: a steering command, and a power command.

10. The control system of claim 9, wherein the power command indicates a power level to be applied by the drive system.

11. The control system of claim 9, wherein the drive system is further operable to turn one or more wheels of the car to change direction of the car based upon receiving the steering command.

12. The control system of claim 9, wherein the acceleration governor is operable to reduce power applied by the drive system when the acceleration signal exceeds a threshold during implementation of each of a steering command and a power command.

13. An radio control car, the car comprising:
four wheels;
a drive system operable to apply power to two or more of the four wheels;
an acceleration sensor operable to sense an acceleration of the car along an axis of the car and to provide an acceleration signal corresponding to the acceleration;
an acceleration governor operable to reduce power applied by the drive system when the acceleration signal exceeds a threshold.

14. The car of claim 13, wherein the threshold is a first threshold, and wherein the acceleration governor is operable to allow an increase in power applied by the drive system when the acceleration signal drops below a second threshold.

15. The car of claim 13, wherein the acceleration governor is operable to reduce power applied by the drive system by providing a gating signal to the drive system that causes the drive system to pulse the power applied to the two or more wheels of the car.

16. The car of claim 13, wherein the acceleration is lateral acceleration.

17. The car of claim 13, wherein the control system further comprises:
a radio frequency receiver operable to receive a steering command indicating a direction to turn one or more of the four wheels, and a power command indicating a power level to be applied by the drive system.

18. The car of claim 17, wherein the acceleration governor is operable to reduce power applied by the drive system when the acceleration signal exceeds a threshold during implementation of each of a steering command and a power command.
